(19) United States
(12) Patent Application Publication
(10) Pub. No.: US 2026/0111919 A1
(43) Pub. Date: Apr. 23, 2026

(54) METHOD

(71) Applicant: TOYOTA JIDOSHA KABUSHIKI KAISHA, Toyota-shi (JP)

(72) Inventors: Kenki UEDA, Tokyo (JP); Hideki KAWAI, Tokyo (JP)

(73) Assignee: TOYOTA JIDOSHA KABUSHIKI KAISHA, Toyota-shi (JP)

(21) Appl. No.: 19/307,661

(22) Filed: Aug. 22, 2025

(30) Foreign Application Priority Data
Oct. 18, 2024 (JP) 2024-184433

(51) Int. Cl. G06Q 30/0201; G06F 40/35

(52) U.S. Cl. CPC G06Q 30/020121; G06F 40/35

(57) ABSTRACT

A method executed by an information processing device includes accumulating in a database, each time a sales negotiation is completed, sales negotiation data including text data related to content of the sales negotiation, acquiring search conditions, extracting, from the database, sales negotiation data that matches the search conditions that are acquired, and displaying the sales negotiation data that is extracted on a display unit.

### CROSS-REFERENCE TO RELATED APPLICATION

This application claims priority to Japanese Patent Application No. 2024-184433 filed on Oct. 18, 2024. The disclosure of the above-identified application, including the specification, drawings, and claims, is incorporated by reference herein in its entirety.

### BACKGROUND

### 1. Technical Field

The present disclosure relates to a method.

### 2. Description of Related Art

There is disclosed a dialogue analysis system that records dialogue data based on speech data obtained by recording dialogue contents, extracts dialogues that match conditions specified by a user from the dialogue data, and displays a list of the dialogues.

### SUMMARY

However, there is room for improvement in functionality of searching sales negotiations data based on past machine learning.

An object of the present disclosure is to improve the functionality of searching past sales negotiations data.

A method according to an embodiment of the present disclosure is
a method executed by an information processing device, the method including
accumulating in a database, each time a sales negotiation is completed, sales negotiation data including text data relating to content of the sales negotiation,
acquiring search conditions,
extracting, from the database, sales negotiation data that matches the search conditions that are acquired, and
displaying the sales negotiation data that is extracted on a display unit.

According to one embodiment, the functionality of searching past sales negotiations data can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a configuration of an information processing device according to an embodiment; and

FIG. 2 is a flowchart showing an example of operations of the information processing device in FIG. 1.

### DETAILED DESCRIPTION OF EMBODIMENTS

An embodiment of the present disclosure will be described below with reference to the drawings.

### Outline of Embodiment

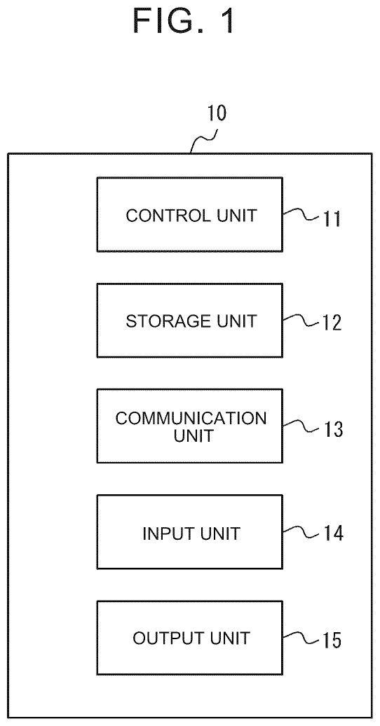

FIG. 1 is a diagram illustrating an example of a configuration of an information processing device 10 according to an embodiment. The information processing device 10 analyzes recordings of dialogs during sales negotiations regarding sales of various goods and services, including automobiles and related products, as well as related services and so forth, for example. Hereinafter, a person who receives goods or services may be referred to as a “customer”, and any person at a retail store who provides the goods or services may be referred to as a “salesperson”. Although the following description will focus on an example of a case in which the information processing device 10 is used for automobile sales, the information processing device 10 may be used for any purpose.

The information processing device 10 is a computer that accumulates and manages past sales negotiation data in a database. The information processing device 10 is, for example, a personal computer (PC) or a tablet terminal or the like, operated by a salesperson, but any type of information processing device 10 may be used. For example, the information processing device 10 may be a computer that is installed in a data center or the like. The information processing device 10 may be, for example, a server belonging to a cloud computing system or any other computing system. The information processing device 10 does not have to be realized by a single device, and may be realized, for example, by mutual communication between a PC, a tablet terminal, and so forth, and a server in the cloud and a network storage.

The information processing device 10 is used by a salesperson during sales negotiations with a customer. The information processing device 10 acquires and manages, as sales negotiations data, speech data of speech that is uttered during sales negotiations recorded with consent of the customer, and information manually input by the salesperson, or the like. The sales negotiation data may include, for example, information regarding customer attributes (e.g., gender, age, occupation, family makeup, hobbies/activities, and so forth) and personal information (e.g., family information, purpose of use, hobbies, lifetime events, living environment, and so forth). The information processing device 10 collects, analyzes, and presents such information, thereby promoting data utilization by retail stores.

An overview of the present embodiment will be given first, and details thereof will be given later. Every time a sales negotiation is completed, the information processing device 10 accumulates sales negotiation data, including text data relating to content of the sales negotiation, in a database. The information processing device 10 acquires search conditions. The information processing device 10 extracts sales negotiation data that matches the search conditions that are acquired from the database. The information processing device 10 displays the sales negotiation data that is extracted on a display unit.

Thus, according to the information processing device 10, sales negotiation data is automatically accumulated in the database every time a sales negotiation is completed. Once search conditions are acquired, sales negotiation data that matches these search conditions is extracted from the database and is displayed. Accordingly, according to the information processing device 10, accuracy of the accumulated sales negotiation data is improved as compared to, for example, an arrangement in which all sales negotiation data is manually input and accumulated in a database.

### Configuration of Information Processing Device 10

FIG. 1 is a block diagram illustrating an example of a configuration of the information processing device 10. The information processing device 10 includes a control unit 11, a storage unit 12, a communication unit 13, an input unit 14, and an output unit 15.

The control unit 11 includes at least one processor, at least one dedicated circuit, or a combination thereof. The processor may be a general-purpose processor such as a central processing unit (CPU), a graphics processing unit (GPU), or the like, or a dedicated processor specifically for specific processing. The dedicated circuit may be a field-programmable gate array (FPGA) or an application-specific integrated circuit (ASIC), for example. The control unit 11 executes processing related to operation of the information processing device 10, while controlling the units of the information processing device 10.

The storage unit 12 includes at least one semiconductor memory, at least one magnetic memory, at least one optical memory, or a combination of at least two thereof. The semiconductor memory is, for example, random access memory (RAM) or read-only memory (ROM). The RAM is, for example, static random access memory (SRAM) or dynamic random access memory (DRAM). The ROM is, for example, electrically erasable programmable read only memory (EEPROM). The storage unit 12 functions as, for example, a main storage device, an auxiliary storage device, or cache memory. The storage unit 12 stores data used for operation of the information processing device 10 and data acquired through operation of the information processing device 10.

The communication unit 13 includes at least one external communication interface. The communication interface may be an interface for either wired communication or wireless communication. In the case of wired communication, the communication interface is, for example, a local area network (LAN) interface or a Universal Serial Bus (USB). In the case of wireless communication, the communication interface is, for example, an interface compatible with mobile communication standards such as LTE (Long Term Evolution), 4G (4th generation), 5G (5th generation), or the like, or an interface compatible with short-range wireless communication such as Bluetooth (registered trademark) or the like. The communication unit 13 receives data used for the operation of the information processing device 10, and also transmits data that is acquired through the operation of the information processing device 10.

The input unit 14 includes at least one input interface. The input interface may include a sound sensor (microphone) for accepting audio input. Also, the input unit 14 may be, for example, a physical key, a capacitive key, a pointing device, or a touch screen that is integrated with a display. Also, the input interface may also be, for example, a camera that accepts gesture input, or the like. The input unit 14 receives operations for inputting data to be used for operation of the information processing device 10. The input unit 14 may be connected to the information processing device 10 as an external input device, instead of being provided in the information processing device 10. As for a connection system, any system such as, for example, USB, High-Definition Multimedia Interface (HDMI) (registered trademark), Bluetooth (registered trademark), or the like can be used.

The output unit 15 includes at least one output interface. The output interface may be, for example, a display that outputs information as video, a speaker that outputs information as audio, or the like. The display may be, for example, a liquid crystal display (LCD) or an organic electroluminescence (EL) display. The output unit 15 may display and output data obtained by the operation of the information processing device 10. The output unit 15 may be connected to the information processing device 10 as an external output device, instead of being provided in the information processing device 10. Any connection system, such as for example, USB, HDMI (registered trademark), Bluetooth (registered trademark), or the like, can be used as a connection system.

Functions of the information processing device 10 are realized by executing a program according to the present embodiment by a processor corresponding to the control unit 11. That is to say, the functions of the information processing device 10 are realized by software. The program causes a computer to function as the information processing device 10 by causing the computer to execute the operations of the information processing device 10. That is to say, the computer functions as the information processing device 10 by executing the operations of the information processing device 10 in accordance with the program.

In the present embodiment, the program can be recorded in a computer-readable recording medium. The computer-readable recording medium includes a non-transitory computer-readable recording medium such as for example, a magnetic recording device, an optical disc, a magneto-optical recording medium, or semiconductor memory. Distribution of the program is carried out, for example, by selling, transferring, or renting a portable recording medium such as a digital versatile disc (DVD), compact disc read-only memory (CD-ROM), or the like, in which the program is recorded. Also, distribution of the program may be performed by storing the program in storage of an external server and transmitting the program from the external server to another computer. Further, the program may be provided as a program product.

Part or all of the functions of the information processing device 10 may be realized by a dedicated circuit corresponding to the control unit 11. That is to say, part or all of the functions of the information processing device 10 may be realized by hardware.

### Operation Example

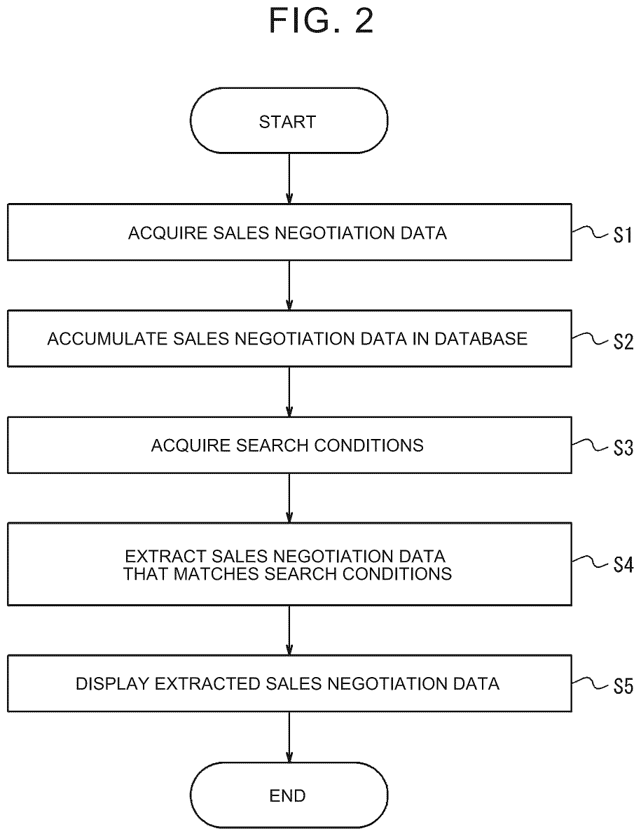

FIG. 2 is a flowchart showing an example of operations of the information processing device 10 in FIG. 1. Operations of the information processing device 10 that are described with reference to FIG. 2 may correspond to one of methods of the information processing device 10. The operations of the steps in FIG. 2 may be executed under control of the control unit 11 of the information processing device 10. The following process may be executed, for example, in situations of sales negotiations.

In step S1, the control unit 11 of the information processing device 10 acquires sales negotiation data.

Specifically, the control unit 11 acquires, as sales negotiation data, speech data of the speech uttered during the sales negotiation that is recorded with the consent of the customer, and information and so forth manually input by the salesperson. Note that in addition to the above information, the control unit 11 may also acquire information obtained by any sensor as sales negotiation data. For example, the control unit 11 may acquire shot images of the customer and the salesperson as sales negotiation data. The control unit 11 may acquire information indicating intonation of a speaker, volume of the speech, gestures and facial expressions of the customer and the salesperson, and so forth, detected from such information, as sales negotiation data. The control unit 11 may acquire such sales negotiation data as text data.

In step S2, the control unit 11 accumulates the sales negotiation data that is acquired in step S1 in a database.

Specifically, the control unit 11 may accumulate the sales negotiation data in a database that is constructed in the storage unit 12, or in a database that is constructed in an external device with which communication can be performed via the communication unit 13. The control unit 11 may accumulate sales negotiation data in the database every time a sales negotiation is completed.

In step S3, the control unit 11 acquires search conditions.

Specifically, the control unit 11 may acquire search conditions that are input by a salesperson. Alternatively, the control unit 11 may analyze sales negotiation data of a sales negotiation that is currently in progress, and automatically acquire search conditions. The control unit 11 may acquire search conditions by analyzing speech data related to the utterances of the salesperson. For example, the control unit 11 may acquire search conditions such as a vehicle type search, a person in charge search, a date and time search, a free word search, or the like. The search conditions may be acquired, for example, by a user inputting the search conditions into interactive artificial intelligence (AI).

In step S4, the control unit 11 extracts, from the database, sales negotiation data that matches the search conditions that are acquired in step S3.

In step S5, the control unit 11 causes the display unit of the output unit 15 to display the sales negotiation data that is extracted in step S4. When the processing of step S5 is completed, the control unit 11 ends the processing of the flowchart.

In this way, according to the method of the present disclosure, sales negotiation data is automatically accumulated in the database each time a sales negotiation is completed. Once search conditions are acquired, sales negotiation data that matches these search conditions is extracted from the database and is displayed. Accordingly, according to the method of the present disclosure, accuracy of the sales negotiation data that is accumulated is improved as compared to, for example, an example in which part of the sales negotiation data is accumulated in a database by manual input.

The information processing device 10 also accumulates sales negotiation data including text data based on speech data, transcription data, or the like, in a database, and searches for past sales negotiation data using search conditions such as vehicle model, staff member in charge, sales negotiation date and time, and so forth. Also, the information processing device 10 can search for sales negotiations in which specific keywords were uttered, using a free word search, as well. Accordingly, for example, when a new model is released, past sales negotiations can be searched, such as by extracting customers who have had sales negotiations for similar models in the past or the like, so as to make data analysis more efficient even in situations regarding which implementation has been difficult with conventional configurations.

Note that the information processing device 10 may acquire sales negotiation data of new sales negotiations between start and end of a new sales negotiation. The information processing device 10 may acquire information indicating characteristics of new sales negotiations as search conditions based on sales negotiation data of the new sales negotiations. The information processing device 10 may extract sales negotiation data that matches the search conditions that are acquired from the database. The information processing device 10 may display the sales negotiation data that is extracted on the display unit of the output unit 15.

In such a configuration, information indicating characteristics of a new sales negotiation is used as search conditions, and sales negotiation data that matches the search condition is extracted from the database and displayed. Accordingly, progress of a currently ongoing sales negotiation can be predicted from the sales negotiation data of past sales negotiations.

Also, the information processing device 10 may acquire, as sales negotiation data of a new sales negotiation, data including a change over time in an index value that evaluates the sales negotiation content of the new sales negotiation, based on a predetermined criterion. Such an index value may be a parameter or the like indicating the possibility of closing a sales negotiation, willingness of a customer to purchase an automobile, or the like. Such index values may be calculated using a trained model that is obtained by analyzing past sales negotiation data. The information processing device 10 may acquire, as search conditions, a pattern of a change over time in an index value included in sales negotiation data of a new sales negotiation.

According to this configuration, a pattern of change over time in the index value that evaluates the sales negotiation content of a new sales negotiation based on a predetermined criterion is used as search conditions, and sales negotiation data that matches the search conditions is extracted from the database and displayed. Thus, according to the method of the present disclosure, progress of a currently ongoing sales negotiation can be accurately predicted from sales negotiation data of past sales negotiations. That is to say, the sales negotiation data of past sales negotiations in which the pattern of change over time of the index value matches the currently ongoing sales negotiation is extracted and displayed, and accordingly the salesperson partway through the sales negotiation can have higher predictability of the sales negotiation. Accordingly, for example, in a case in which the salesperson senses a decrease in the likelihood of closing a sales negotiation or in the motivation of the customer to purchase an automobile, the salesperson may give up on the customer and reduce sales activities toward the customer. Alternatively, the salesperson may select measures that will increase the likelihood of closing a sales negotiation based on past sales negotiation data.

Also, the information processing device 10 may accumulate, in the database, sales negotiation data further including text data summarizing the contents of the sales negotiation.

According to this configuration, the sales negotiation data that is accumulated in the database includes text data summarizing the contents of the sales negotiations, such that sales negotiation data that matches the search conditions is displayed including a summary of the contents of the sales negotiations, allowing the salesperson to easily confirm the desired sales negotiation data.

Furthermore, the information processing device 10 may acquire search conditions (step S3) and display extracted (past) sales negotiation data (steps S4 and S5), while a new sales negotiation is ongoing. For example, the salesperson may input search conditions into an interactive AI during a sales negotiation.

The present disclosure is not limited to the embodiment described above. For example, a plurality of blocks illustrated in a block diagram may be integrated, or one block may be divided. A plurality of steps indicated in the flowchart may be executed in parallel, or in a different order, in accordance with the processing capability of the device that executes the steps, or as necessary, rather than being executed chronologically in accordance with the description. Other changes can be made without departing from the spirit and scope of the present disclosure.

Also, for example, the configurations and the operations of the information processing device 10 may be distributed among a plurality of computers that are capable of communicating with each other. Also, for example, part or all of the components of the information processing device 10 may be provided in another device, such as a server in the cloud, network storage, or the like.

Part of the embodiment according to the present disclosure is exemplified below. It should be noted, however, that the embodiment of the present disclosure is not limited thereto.

### Appendix 1

A method executed by an information processing device, the method including
accumulating in a database, each time a sales negotiation is completed, sales negotiation data including text data relating to content of the sales negotiation,
acquiring search conditions,
extracting, from the database, sales negotiation data that matches the search conditions that are acquired, and
displaying the sales negotiation data that is extracted on a display unit.

### Appendix 2

The method according to appendix 1, further including acquiring sales negotiation data for a new sales negotiation, between start and end of the new sales negotiation,
acquiring information indicating characteristics of the new sales negotiation as the search conditions, based on the sales negotiation data of the new sales negotiation,
extracting, from the database, sales negotiation data that matches the search conditions that are acquired,
displaying the sales negotiation data that is extracted on the display unit.

### Appendix 3

The method according to appendix 2, further including acquiring, as sales negotiation data of the new sales negotiation, data including change over time in an index value that evaluates sales negotiation content of this new sales negotiation, based on a predetermined criterion and
acquiring a pattern of change over time of the index value that is included in the sales negotiation data of the new sales negotiation, as the search conditions.

### Appendix 4

The method according to any one of appendices 1 to 3, further including accumulating, in the database, sales negotiation data that further includes text data summarizing the content of the sales negotiation.

What is claimed is:

1. A method executed by an information processing device, the method comprising:
accumulating in a database, each time a sales negotiation is completed, sales negotiation data including text data relating to content of the sales negotiation;
acquiring search conditions;
extracting, from the database, sales negotiation data that matches the search conditions that are acquired; and
displaying the sales negotiation data that is extracted on a display unit.

2. The method according to claim 1, further comprising:
acquiring sales negotiation data for a new sales negotiation, between start and end of the new sales negotiation;
acquiring information indicating characteristics of the new sales negotiation as the search conditions, based on the sales negotiation data of the new sales negotiation;
extracting, from the database, sales negotiation data that matches the search conditions that are acquired; and
displaying the sales negotiation data that is extracted on the display unit.

3. The method according to claim 2, further comprising:
acquiring, as sales negotiation data of the new sales negotiation, data including change over time in an index value that evaluates sales negotiation content of this new sales negotiation, based on a predetermined criterion; and
acquiring a pattern of change over time of the index value that is included in the sales negotiation data of the new sales negotiation, as the search conditions.

4. The method according to claim 1, further comprising accumulating, in the database, sales negotiation data that further includes text data summarizing the content of the sales negotiation.
